(19) United States
(12) Patent Application Publication
(10) Pub. No.: US 2020/0202386 A1
(43) Pub. Date: Jun. 25, 2020

(54) METHOD, APPARATUS, AND COMPUTER PROGRAM PLATFORM FOR DYNAMIC LOCATION BASED MOBILE ADVERTISING

(71) Applicant: HERE Global B.V., Eindhoven (NL)

(72) Inventors: James Fowe, Chicago, IL (US); Timothy Garcia, Westport, CT (US)

(73) Assignee: HERE Global B.V., Eindhoven (NL)

(21) Appl. No.: 16/228,890

(22) Filed: Dec. 21, 2018

(51) Int. Cl. G06Q 30/02; G06K 9/00; H04W 4/021

(52) U.S. Cl. CPC G06Q 30/0266; G06Q 30/0261; G06Q 30/0271; H04W 4/021; G06K 9/00375; G06K 9/00778; G06K 9/00288

(57) ABSTRACT

A method, apparatus, and computer program product are provided for mobile advertising in a given area. In the context of the method, the method includes accessing pedestrian location information for the given area. In response to the provided pedestrian location information and based on a position of a mobile robot, the method also includes determining a display location containing one or more pedestrians within the given area for the mobile robot to display a mobile message. The method further includes providing advertisement information to be included in the mobile message to be provided by the mobile robot to at least one of the one or more pedestrians in the display location. A corresponding apparatus and computer program product are also provided.

### TECHNOLOGICAL FIELD

An example embodiment relates generally to mobile advertising within a given area and, more particularly, to determining the location and advertisement type for mobile robots to provide to pedestrians.

### BACKGROUND

Advertisements are an integral part of successful companies. Through history, word of mouth advertising evolved into other mediums including print, radio, and television. All mediums of advertising have limitations in regards to reach and ability to target specific users. For example, television advertisements allow for estimations of the demographics of those they are attempting to reach, but requires that people “opt-in” by owning and watching television. When a household does not have, or does not watch, television, then the advertisement reaches no one in the household. Outside of the household, billboards and signs have been used for over 100 years with varying degrees of success. However, the static nature of these advertising methods make it difficult to target audiences. For example, a billboard may be in an area that is only busy for a certain amount of time in a day and the rest of the day has little to no advertising value.

### BRIEF SUMMARY

A method, apparatus and computer program product are provided in accordance with an example embodiment in order to facilitate mobile advertising in a given area. Advancements in technology have allowed for more targeted advertising to consumers, including pedestrians. Pedestrians are often inundated with a variety of advertisements, especially in populated areas. The method, apparatus, and computer program product of an example embodiment are provided to allow for advertisements to be mobile, dynamic, and targeted towards certain pedestrians, which allows them to be more effective than traditional pedestrian advertisements, such as static billboards. The mobile robots equipped with an example embodiment are able to choose the location of advertising and/or the type of advertisement based on various factors in order to maximize the effectiveness of their advertising.

In an example embodiment, a method is provided for mobile advertising within a given area. The method includes accessing pedestrian location information for the given area. The pedestrian location information is based on at least one of a historical pedestrian flow, a real-time pedestrian flow, or a digital map of walkways. In response to the provided pedestrian location information and based on a position of a mobile robot, the method includes determining a display location containing one or more pedestrians within the given area for the mobile robot to display a mobile message. The method includes providing advertisement information to be included in the mobile message to be provided by the mobile robot to at least one of the one or more pedestrians in the display location based on the display location determined.

In some embodiments, the determination of a display location is also based on the location of one or more other mobile robots. In some embodiments, the method also includes altering the mobile message based on an interaction by at least one of the one or more pedestrians in the display location. In an example embodiment, the method also includes collecting data based on one or more interactions with at least one of the one or more pedestrians.

In some embodiments, the method also includes determining the advertisement information to be provided based on at least one characteristic of the one or more pedestrians in the display location. The at least one characteristic of the one or more pedestrians in the display location used to determine the advertisement information to be provided includes at least one of gender, age, height, or weight. In an example embodiment, the method also includes selecting the at least one of the one or more pedestrians in the display location to display the mobile message based on at least one characteristic of the one or more pedestrians in the display location.

In an example embodiment, the method also includes selecting the at least one of the one or more pedestrians to display the mobile message based on at least one of facial recognition or gesture recognition. In some embodiments, the method also includes interacting with one or more additional robots to provide one or more mobile messages to more than one display location. In some embodiments, the method also includes causing the transmission of the mobile message to at least one of the one or more pedestrians in the display location.

In an example embodiment, an apparatus is provided for determining a location of a mobile advertisement robot. The apparatus includes at least one processor and at least one non-transitory memory including computer program code instructions with the computer program code instructions configured to, when executed, cause the apparatus to access pedestrian location information for the given area. The pedestrian location information is based on at least one of a historical pedestrian flow, a real-time pedestrian flow, or a digital map of walkways. In response to the provided pedestrian location information and based on a position of a mobile robot, the computer program instructions are configured to, when executed, cause the apparatus to determine a display location containing one or more pedestrians within the given area for the mobile robot to display a mobile message. The computer program instructions are further configured to, when executed, cause the apparatus to provide advertisement information to be included in the mobile message to be provided by the mobile robot to at least one of the one or more pedestrians in the display location based on the display location determined.

In an example embodiment, the determination of a display location is also based on the location of one or more other mobile robots. In some embodiments, the computer program code instructions are further configured to, when executed, cause the apparatus to alter the mobile message based on one or more interactions by at least one of the one or more pedestrians in the display location. In some embodiments, the computer program code instructions are further configured to, when executed, cause the apparatus to collect data based on one or more interactions with at least one of the one or more pedestrians.

In an example embodiment, the computer program code instructions are further configured to, when executed, cause the apparatus to determine the advertisement information to be provided based on at least one characteristic of the one or more pedestrians in the display location. In such a case, at least one characteristic of the one or more pedestrians in the display location used to determine the advertisement information to be provided includes at least one of gender, age, height, or weight.

In an example embodiment, the computer program code instructions are further configured to, when executed, cause the apparatus to select the at least one of the one or more pedestrians in the display location to display the mobile message based on at least one characteristic of the one or more pedestrians in the display location. In some embodiments, the computer program code instructions are further configured to, when executed, cause the apparatus to select the at least one of the one or more pedestrians to display the mobile message based on at least one of facial recognition or gesture recognition. In some embodiments, the computer program code instructions are further configured to, when executed, cause the apparatus to cause the transmission of the mobile message to at least one of the one or more pedestrians in the display location.

In yet another example embodiment, a computer program product is provided that includes at least one non-transitory computer-readable storage medium having computer-executable program code portions stored therein with the computer-executable program code portions comprising program code instructions configured to access pedestrian location information for the given area. The pedestrian location information is based on at least one of a historical pedestrian flow, a real-time pedestrian flow, or a digital map of walkways. In response to the provided pedestrian location information and based on a position of a mobile robot, the computer-executable program code portions include program code instructions also configured to determine a display location containing one or more pedestrians within the given area for the mobile robot to display a mobile message. The computer-executable program code portions further include program code instructions configured to provide advertisement information to be included in the mobile message to be provided by the mobile robot to at least one of the one or more pedestrians in the display location based on the display location determined.

In an example embodiment, the determination of a display location is also based on the location of one or more other mobile robots. In some embodiments, the computer code instructions are further configured to alter the mobile message based on one or more interactions by at least one of the one or more pedestrians in the display location. In some embodiments, the program code instructions are further configured to determine the advertisement information to be provided based on at least one characteristic of the one or more pedestrians in the display location. In such a case, the at least one characteristic of the one or more pedestrians in the display location used to determine the advertisement information to be provided includes at least one of gender, age, height, or weight.

In an example embodiment, the program code instructions are further configured to select the at least one of the one or more pedestrians in the display location to display the mobile message based on at least one characteristic of the one or more pedestrians in the display location. In some embodiments, the program code instructions are further configured to cause the transmission of the mobile message to at least one of the one or more pedestrians in the display location.

In still another example embodiment, an apparatus is provided for mobile advertising within a given area that includes means for accessing pedestrian location information for the given area. The pedestrian location information is based on at least one of a historical pedestrian flow, a real-time pedestrian flow, or a digital map of walkways. In response to the provided pedestrian location information and based on a position of a mobile robot, the apparatus includes means for determining a display location containing one or more pedestrians within the given area for the mobile robot to display a mobile message. The apparatus includes means for providing advertisement information to be included in the mobile message to be provided by the mobile robot to at least one of the one or more pedestrians in the display location based on the display location determined.

In some embodiments, the determination of a display location is also based on the location of one or more other mobile robots. In some embodiments, the apparatus also includes means for altering the mobile message based on an interaction by at least one of the one or more pedestrians in the display location. In an example embodiment, the apparatus also includes means for collecting data based on one or more interactions with at least one of the one or more pedestrians.

In some embodiments, the apparatus also includes means for determining the advertisement information to be provided based on at least one characteristic of the one or more pedestrians in the display location. The at least one characteristic of the one or more pedestrians in the display location used to determine the advertisement information to be provided includes at least one of gender, age, height, or weight. In an example embodiment, the apparatus also includes means for selecting the at least one of the one or more pedestrians in the display location to display the mobile message based on at least one characteristic of the one or more pedestrians in the display location.

In an example embodiment, the apparatus also includes means for selecting the at least one of the one or more pedestrians to display the mobile message based on at least one of facial recognition or gesture recognition. In some embodiments, the apparatus also includes means for interacting with one or more additional robots to provide one or more mobile messages to more than one display location. In some embodiments, the apparatus also includes means for causing the transmission of the mobile message to at least one of the one or more pedestrians in the display location.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a block diagram of an apparatus that may be specifically configured in accordance with an example embodiment of the present disclosure;

FIG. 2 is an example environment with a plurality of different mobile robots in accordance with example embodiments of the present disclosure interacting with one another and the network to provide advertising information to pedestrians;

FIG. 3 is a flowchart of the operations performed, such as by the apparatus of FIG. 1, in order to effectively advertise to pedestrians; and

FIG. 4 is an example configuration of the network that one or more mobile robots, equipped with an apparatus according to an example embodiment of the present disclosure may be connected.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. The term advertisement may be used to mean any information that may be provided to a pedestrian. Thus, use of any such terms should not be taken to limit the spirit and scope of embodiments of the present invention.

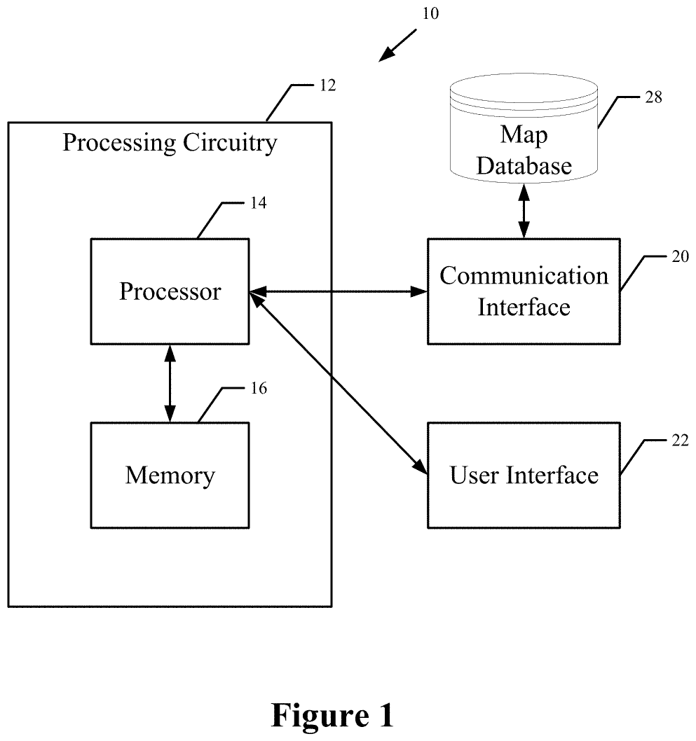

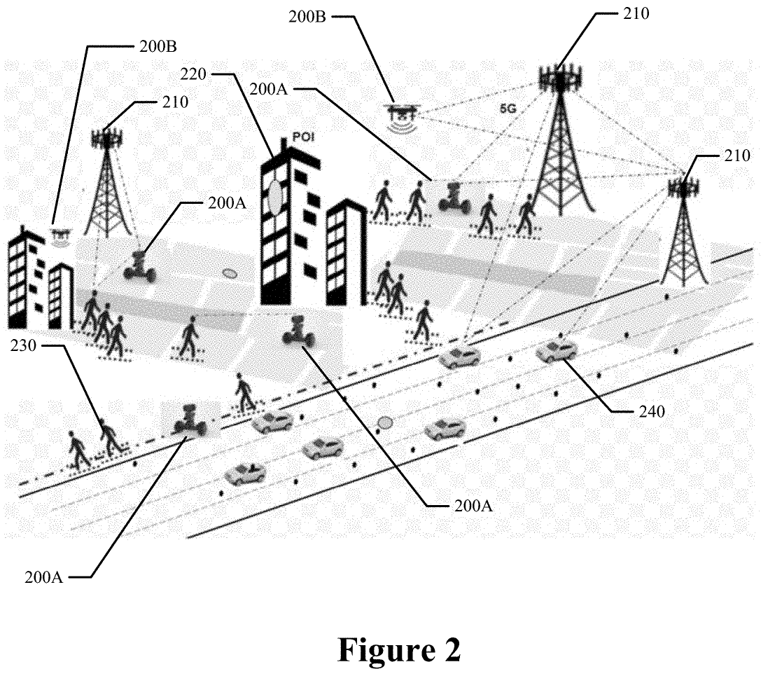

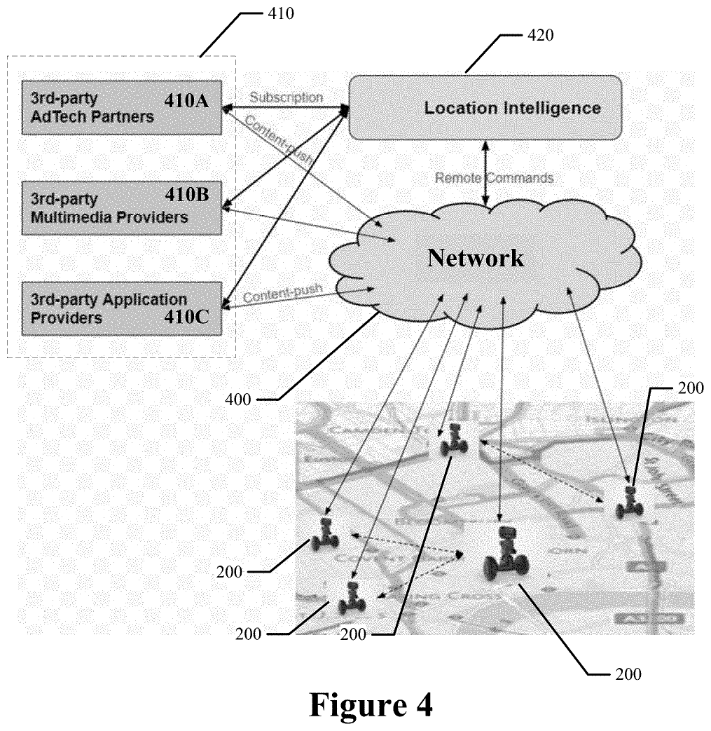

One example of a mobile robot, such as the mobile robot 200 of FIG. 2, may utilize the apparatus, method and computer program product of an example embodiment in order to provide advertising information. The apparatus of the illustrated embodiment includes a processing circuitry 12, including a processor 14 and a memory device 16, a communication interface 20, a user interface 22, and a geographic map database 28. A mobile robot may either include or be in communication with an apparatus of an example embodiment, such as the apparatus 10 of FIG. 1. For example, the mobile robot may be in communication with the apparatus through a wireless network, such as the network 400 shown in FIG. 4.

FIG. 1 is a schematic diagram of an example apparatus 10 configured for performing any of the operations in accordance with an example embodiment as described herein. Apparatus 10 may be embodied by or associated with any of a variety of computing devices that include or are otherwise associated with a device configured for providing mobile advertisements to pedestrians. For example, the computing device may at least partially control autonomous features of a mobile robot, including the positioning of the robot, presentation provided by the robot, and the like. In other embodiments of the apparatus, the apparatus itself may be embodied or partially embodied as a mobile terminal, such as a personal digital assistant (PDA), mobile telephone, smart phone, personal navigation device, smart watch, tablet computer, camera or any combination of the aforementioned and other types of voice and text communications systems that are in communication with one or more mobile robots. In one embodiment the apparatus 10 is embodied or partially embodied by an electronic control unit of a mobile robot. Alternatively, the computing device may be a fixed computing device in communication with one or more mobile robots remotely, such as through cloud technology.

Optionally, the apparatus 10 may be embodied by or associated with a plurality of computing devices that are in communication with or otherwise networked with one another and the mobile robot such that the various functions performed by the apparatus may be divided between the plurality of computing devices that operate in collaboration with one another.

The apparatus 10 may include, be associated with, or may otherwise be in communication with a processing circuitry 12, which includes a processor 14 and a memory device 16, a communication interface 20, and a user interface 22. In some embodiments, the processor 14 (and/or co-processors or any other processing circuitry assisting or otherwise associated with the processor) may be in communication with the memory device 16 via a bus for passing information among components of the apparatus. The memory device 16 may be non-transitory and may include, for example, one or more volatile and/or non-volatile memories. In other words, for example, the memory device 16 may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

The processor 14 may be embodied in a number of different ways. For example, the processor 14 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 14 may be configured to execute instructions stored in the memory device 16 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, the computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 10 of an example embodiment may also include or otherwise be in communication with a user interface 22. The user interface may include a touch screen display, a speaker, physical buttons, and/or other input/output mechanisms. In an example embodiment, the processor 14 may comprise user interface circuitry configured to control at least some functions of one or more input/output mechanisms. The processor and/or user interface circuitry comprising the processor may be configured to control one or more functions of one or more input/output mechanisms through computer program instructions (for example, software and/or firmware) stored on a memory accessible to the processor (for example, memory device 16, and/or the like). The user interface may be embodied in the same housing as the processing circuitry, such as in a mobile robot. Alternatively, the user interface may be separate from the processor circuitry 12. For example, the user interface may be carried by the mobile robot, while the processing circuitry is in communication with the mobile robot remotely, such as through a network.

The apparatus 10 of an example embodiment may also optionally include a communication interface 20 that may be any means such as a device or circuitry embodied in either hardware or a combination of hardware and software that is configured to receive and/or transmit data from/to other electronic devices in communication with the apparatus, such as by near field communication (NFC) or other proximity-based techniques, such as Bluetooth, in order to communicate with mobile robots that are nearby. Additionally or alternatively, the communication interface may be configured to communicate via cellular or other wireless protocols including Global System for Mobile Communications (GSM), such as but not limited to 4G, 5G, and Long Term Evolution (LTE). In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired or wireless communication for mobile robot to mobile robot or mobile robot to infrastructure wireless links.

The apparatus 10 may have a mapping or navigation interface so as to use maps in order to move and operate a mobile robot across a given area. In order to support a mapping application, the computing device may include or otherwise be in communication with a geographic map database 28, such as may be stored in memory 16 or is otherwise accessible to the processor, such as in map database 28. For example, the geographic map database 28 includes node data records, sidewalk segment or link data records, point of interest (POI) data records, and other data records. More, fewer, or different data records can be provided. In one embodiment, the other data records include cartographic data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or Global Positioning System (GPS) data associations (such as using known or future map matching or geo-coding techniques), for example. Some map data for sidewalks may be derived from road data corresponding to nearby road segments. For example, busy roads in some areas may have higher pedestrian traffic than less busy roads. Furthermore, other positioning technology may be used, such as electronic horizon sensors, radar, Light Detection and Ranging (LiDAR), ultrasonic and/or infrared sensors.

The map database 28 may include node data, path segment data, point of interest (POI) data, or the like. The map database may also include cartographic data, routing data, and/or maneuvering data. According to some example embodiments, the path segment and node data records or other data that may represent pedestrian paths or areas. The node data may be end points corresponding to the respective links or segments of path segment data. The path data and the node data may represent a path network, such as used by pedestrians, bicycles, mobile robots, and/or other entities. Optionally, the map database may contain road segment data records may be links or segments representing roads, streets, or paths, as may be used in calculating a route or recorded route information for determination of one or more personalized routes in addition to or instead of the pedestrian walkway record data, for example. The road link data and the node data may represent a road network, such as used by vehicles, cars, trucks, buses, motorcycles, and/or other entities. The path segments and nodes data, as well as the road/link segments and nodes data, can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database can include data about the POIs and their respective locations in the POI records. The map database may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database can include event data (e.g., traffic incidents, construction activities, scheduled events, unscheduled events, etc.) also known as a context associated with the POI data records or other records of the map database.

The map database 28 may be a master map database stored in a format that facilitates updating, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions. The navigation-related functions can correspond to mobile navigation, pedestrian navigation, or other types of navigation. While example embodiments described herein generally relate to mobile robot and pedestrian travel along walkways, example embodiments may be implemented for vehicle travel along roads, bicycle travel along bike paths, boat travel along maritime navigational routes, etc.

As mentioned above, the map database 28 may be a master geographic database stored or accessible on the server side. However, in alternate embodiments, a client side map database may represent a compiled navigation database that may be used by mobile robots for navigation purposes.

In some embodiments, the apparatus 10, such as the one shown in FIG. 1, may be included within and carried by or may be remote from, but in communication with one or more mobile robots. In an example embodiment where the apparatus is carried by a mobile robot, the apparatus may be embodied by the computer that is configured to operate the mobile robot. Alternatively, the apparatus may operate independently of the computer that operates the robot and communicates with the computer, such as by providing information to be used by the computer operating the mobile robot. For example, the processor circuitry 12 of apparatus 10 of one embodiment may also be configured to operate a portion or all of the mobile robot. The mobile robot, such as the computer that operates the robot, may also use the map database 28 discussed above to maneuver through an area. For example, the map database 28 may provide the best path for a given mobile robot to travel to a display location. In some embodiments, the mobile robot may use a distinct map database for operational purposes that is different, at least in part, from the map database 28 used by the apparatus. For example, the map database used by the apparatus may contain information relating to Points of Interest (POI) in a city, while the map database used by the mobile robot may contain information relating to the traffic on the sidewalks along the path for the mobile robot.

Referring now to FIG. 2, an example environment with a plurality of mobile robots, in accordance with example embodiments of the present disclosure, interacting with one another and the network to provide mobile messages to pedestrians based on advertising information is provided. Advertising information and advertisements discussed herein may be any information that may be provided to a pedestrian for an informative or advertising purpose. In some embodiments, the advertising information and advertisements may include attempts to sell goods or services, informational messages (e.g., emergency signals), and the like.

The mobile robots 200 may be either equipped with or in communication with an apparatus of an example embodiment, such as the apparatus 10 shown in FIG. 1. As discussed below, the connection to the network and other mobile robots may be through one connection type (e.g., cellular connection) or through multiple different connection types (e.g., both cellular connection and proximity based connection).

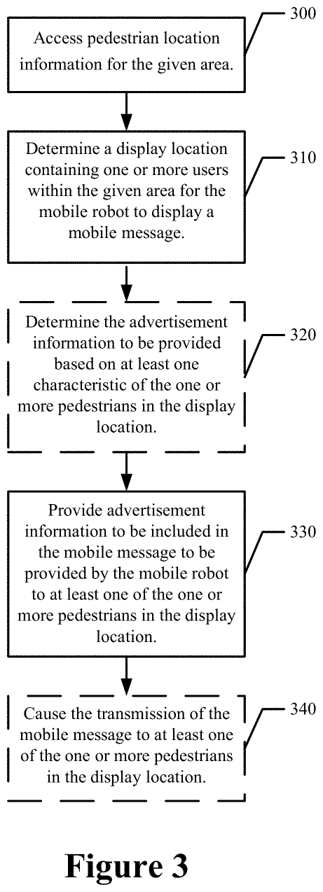

As shown, there may be multiple mobile robots 200 that are operating in a given area. A mobile robot may be any transitory system capable of carrying out complex operations. The mobile robots may be digital out of home (DOOH) billboards that are mobile. The mobile robots may be connected to one another through a network, such as a wireless communication network. Alternatively, a mobile robot may not be connected to a network and may be operated independently. In such an embodiment when the mobile robots are connected to one another, the multiple mobile robots may be able to coordinate with one another, such as by using swarm intelligence. Additionally, as shown in more detail in FIG. 3, the network 400 may provide connections between network participants including the mobile robots via cellular or other wireless protocols including Global System for Mobile Communications (GSM), such as but not limited to 4G, 5G, LTE, and the like. In some embodiments, the apparatus 10 may be remote from the mobile robot and communicably connected through the network. One or more mobile robots may be equipped with Computer Vision Technology (CVT). In some embodiments, as discussed below, the CVT may allow for visual interactions with humans through facial and/or gesture recognition. In an example embodiment, the apparatus 10 may include, or be in communication with, one or more sensors used for facial and/or gesture recognition. Potential sensor types include structured-light 3D scanner, radar, Light Detection and Ranging (LiDAR), ultrasonic and/or infrared sensors. Additionally, CVT may also be used to track the number of pedestrians in a given area. The facial and/or gesture recognition will be discussed below in reference to FIG. 3.

In some embodiments, the mobile robot may include, such as in the memory device 16 or map database 28, or be in communication with, a digital map including the walkways, such as through the communication interface 20. In an example embodiment, the mobile robots may use the digital maps to move around an area, such as a city. As discussed in more detail below, in some embodiments the types of advertisement presented by a mobile robot may be determined using advertising technology services including, but not limited to, programmatic, real-time bidding, private networks, private marketplaces, exchanges, demand side platforms and supply side platforms. For example, advertising technology may be able to create targeted advertisements using location intelligence and human computer interaction (HCI). The type of advertisement provided may be determined by one or many demographic characteristics including age, gender, height, weight, location relevancy, etc. HCI may involve receiving inputs from one or more pedestrians to determine the targeted advertisement to use. The HCI may be obtained in real-time or come from previous human interaction (e.g., studies on the subject).

In some embodiments, the mobile robot(s) may interact with other types of advertisements, both intelligent (e.g., stationary electronic billboards) or otherwise (e.g. traditional advertisements like signs or non-electric billboards). For intelligent advertisements, the mobile robot(s) may be able to communicate directly and can either complement or avoid the stationary advertisements. For example, there may be multiple electronic billboards in a city center and the type of advertisements on those stationary advertisements may change the type of advertisements chosen by a mobile robot operating in the same general area. In some embodiments, one or more mobile robots may be used to complement other static or dynamic billboards that are stationary in nature. In other embodiments, one or more mobile robots may be deployed to provide competition to other static or dynamic billboards that are stationary in nature. For example, a mobile robot may display a specific advertisement for a competitor of a brand that has a stationary billboard in a given area. In other embodiments, known types of static advertisements (e.g., non-electronic billboards) may be included in a database, such as the map database 28. In such a case, the location of the stationary advertisements may be treated similarly to other mobile robots when determining a display location. In other words, the other types of known advertisements may be a factor in which location within an area should be the display location for a given mobile robot. For example, some areas with a large amount of advertisements, either stationary or mobile, may have high pedestrian foot traffic, but additional advertisements in the same area may not have the same effectiveness as areas with less pedestrians and fewer advertisements. In some embodiments, the size of the other advertisements may also be a factor (e.g., large advertisements may destroy the effectiveness of smaller advertisements).

In some embodiments, a mobile robot may be land based (e.g., the mobile robot 200A of FIG. 2). The type of mobile robot (e.g., land based versus other types) may affect the determination of the display location and/or the type of advertisements displayed. For example, the land based mobile robots 200A may be more affected by the amount of pedestrian 230 density than other types of mobile robots. For example, the land based mobile robots may need a certain amount of space to maneuver effectively. In some embodiments, the size of the land based mobile robot may be based on the expected operating conditions, such as the size of crowds, the type of advertisements, the size of the area of operation (e.g., size of the sidewalks), and/or the like. For example, smaller mobile robots may be more effective than large mobile robots where there is a high pedestrian density (e.g., a busy sidewalk or sporting event) and/or the area of operation is small (e.g., narrow sidewalks).

In other embodiments, a mobile robot may be non-land based (e.g., the drone 200B of FIG. 2). As noted above, the type of mobile robot may affect the determination of the display location and/or the type of advertisements to be displayed. The air based mobile robots may include drones (e.g., drone 200B of FIG. 2), while other non-land based mobile robots may include water vehicles or the like. In some embodiments, non-land based mobile robots may be able to cover some or all of the same area as a land based mobile robot (e.g., a drone may be able to operate at the same locations as a land based mobile robot). Alternatively, non-land based mobile robots may cover areas that land based mobile robots cannot operate (e.g., a water vehicle may operate in the water where a land based mobile robot could not). In some embodiments, the type of mobile robot may affect the determination of the display location for the mobile message. In an example embodiment, a non-land based mobile robot may weigh factors differently when considering which display areas should be targeted compared to land based mobile robots. For example, air based mobile robots may not require a minimum amount of space to pass between people as a land based mobile robot may require. Additionally or alternatively, non-land based mobile robots may have to consider additional factors in determining the appropriate display location at a given time. For example, air based mobile robots may need to consider whether an area has a ceiling or potential barriers for effective flight. In some embodiments, the air based mobile robots may be able to directly travel to a display location, as opposed to only being able to travel on the sidewalk. The flight of travel may affect the determination of the display location for the drones. For example, an air based mobile robot may be able to travel diagonally across blocks (except when buildings are in the way) and may be able to get to a location faster than a land based mobile robot, which may be restricted to straight line travel.

In some embodiments, mobile robots (land based mobile robots and/or the non-land based mobile robots) equipped with, or in communication with, an apparatus 10 of an example embodiment may have functionality allowing them to observe off limit areas. An off limit area may be any area where a mobile robot should not be operating. For example, some areas, such as a heavily populated area or a church, may have laws restricting advertisements in such areas, either completely or during certain times. Additionally, for air based mobile robots, there may be certain no fly areas in which flight is restricted or prohibited. In such a case, the digital map may be configured to identify off-limit areas so that the mobile robot(s) can be diverted. Additionally, the off limit areas may include areas where the mobile robot may not operate effectively. For example, a land based mobile robot may not operate well on an uneven grass field. Alternatively, for example, a water based mobile robot may not be able to function on land and therefore any land would be an off limit area for a water based mobile robot. The determination of the area for a mobile robot to operate may be based on the capability of the mobile robot. For example, all-terrain mobile robots may be used in an area with varying elevations.

In some cases, a given area may have multiple mobile robots. Some areas, such as the one shown in FIG. 2, may have multiple mobile robots with at least one of each a land based mobile robot and an air based mobile robot. In some embodiments, land based mobile robots and non-land based mobile robots may be configured to complement one another by reaching pedestrians in a display location in different ways. For example, an air based mobile robot may be configured with a speaker announcing an advertisement that includes directing users to nearby land based mobile robots to get additional information and/or rewards relating to a sale or promotion. Alternatively, air based mobile robots may be used in areas where land based mobile robots cannot operate effectively. For example, the makeup of the land and/or the amount of pedestrians may not allow for some land based mobile robots to operate properly in a given area. In such a case, air based mobile robots may be deployed to those areas. For example, at a stadium the configuration of the stands may make it difficult for land based mobile robots to travel effectively. In such cases, air based mobile robots may be deployed and land based mobile robots may either not be deployed at all or may be deployed to areas where they are more effective (e.g., land based mobile robots may be in the concourse of a stadium, while air based mobile robots are deployed in the stands).

As discussed throughout, the mobile robot(s) may be communicably connected to a network, such as the network 400 shown in FIG. 4, through a wireless connection. In an example embodiment, an apparatus 10 may be in communication, such as through the communication interface 20, with one or more cellular towers (e.g., towers 210 in FIG. 2). The cellular tower(s) may also be in communication with other non-mobile robots, such as mobile devices (e.g., a pedestrian's cell phone), vehicles (e.g., the vehicle 240 in FIG. 2), and other user equipment. In some embodiments, the cellular tower(s) may communicate with the mobile robot(s) via cellular or other wireless protocols including Global System for Mobile Communications (GSM), such as but not limited to 4G, 5G, or LTE. Additionally, the tower(s) may pass communications between mobile robot(s) and other parts of the network (e.g., other mobile robots or location intelligence servers). Alternatively, the network of mobile robots may be connected to one another directly through proximity based connections, such as with Near-Field Communication (NFC), Bluetooth, or cellular connections separate from the network 400. The cellular tower(s) may also connect the mobile robots to one or more servers that may include a map database. In some embodiments, the apparatus 10, such as through the communication interface 20 or the like, may be in communication with multiple cellular tower(s) based on proximity. Alternatively, the apparatus 10 may be configured to operate, at least partially, independently of a network and therefore the entire apparatus 10 may be connected to and carried by the mobile robot. In some embodiments, the apparatus 10 may be remote from the mobile robot and may be connected to the robot through the network. In such a case, the apparatus 10, such as the processing circuitry 12, the processor 14, or the like, may provide instructions to one or more mobile robots. In some embodiments, the mobile robot(s) may have a processor, such as a dedicated processor, in addition to the processor 14 of the apparatus 10 for other operations not related to the determination of display locations and/or advertisement types.

In some embodiments, one or more points of interest (POI) 220 may be used to determine the display location for one or more mobile robots. In some embodiments, the POI information may be contained in the map database 28 or may be supplied independent of the map database, such as through the network 400. In certain embodiments, the POI information may be used to determine the type of advertisement to be displayed by the mobile robot, the location for the mobile robot to display an advertisement, or both. For example, a high end theater may attract pedestrians for which advertisements for high end products may be more effective, thereby suggesting that the advertisement be focused on the immediate area around the theater. In another example, advertisements relating to fitness products may be displayed near a gym. In some embodiments, the determination of the type of advertisement may be based on POIs close to a display location or vice versa, that is, the determination of the display location may use POIs, such as the type of POI and/or the type of individuals attracted to the POI, to determine the location based on the type of advertisement being shown. In some embodiments, mobile robots may be used for competitive conquesting through the display of advertisements. For example, a first fast food chain may want to send robots near all restaurants of a second fast food chain to impact the consideration of potential consumers and redirect them towards a restaurant of the first fast food chain. Additionally, POI information may be used to determine areas in which it is not worthwhile to advertise, either permanently or at a specific time. For example, a city may have laws prohibiting solicitations after a certain time in city squares and therefore the location of the city squares may be used to determine the off-limit sections of a city at a given time. Alternatively, there may be permanent off-limit areas determined by the operator of the mobile robots or the law. For example, a company advertising alcohol may decide not to, or not be legally allowed to, advertise near a church or school. In an example embodiment, the apparatus 10, such as the processing circuitry 12, the processor 14, or the like, may use information relating to crime rates to protect mobile robots from being vandalized by avoiding use of mobile robots in areas prone to crime.

In some embodiments, the POI information may be used to create pedestrian location information. As discussed in more detail below, pedestrian location information may be any information that gives an indication about pedestrian traffic at one or more locations. This information may relate to the amount of pedestrians and the demographic characteristics of the pedestrians at one or more locations. In an example embodiment, there may be statistics about a specific or similar POI that allows an estimate of the pedestrian traffic near other similar POIs. For example, a grocery store may create an average amount of pedestrian traffic and that average may be used for specific areas of a city with other comparable grocery stores. In such a case, the information about the POI may be based on the specific POI data for a location (e.g., known pedestrian information by a specific grocery store) or POI data for a similar location (e.g., known pedestrian information for one or more of the same kind of grocery stores). In an example embodiment, POI data for a similar POI may allow an estimation of pedestrian flow for an unknown POI. For example, pedestrian information about an existing store may be used to estimate the increase in traffic for an area when a new store of the same type opens.

In some embodiments, additional non-mobile robot technologies may be connected to the network 400. For example, as shown in FIG. 2, vehicles 250 may also be connected to the network 400. The non-mobile robot technologies may provide information that may be used by the apparatus 10, such as used for pedestrian location information. For example, the non-mobile robot technologies may provide information relating to the amount of pedestrians on a given sidewalk. Examples of non-mobile robot technologies may include mobile devices (e.g., cell phones, smart watches, etc.), vehicles, non-mobile electronic billboards, street furniture (e.g., smart cities may be equipped with the capabilities to monitor pedestrian location information at a given location), and other sensors. For example, a mobile device connected to the network 400 may allow the apparatus, such as with the processor 14, to determine the amount of traffic at a given location (e.g., based on the speed one or more pedestrians are moving on a sidewalk).

Referring now to FIG. 3, the operations performed by the apparatus 10 of an example embodiment of the present disclosure includes means, such as the processing circuitry 12, the processor 14, or the like, for providing mobile advertising within a given area. While throughout the application the apparatus is described to be in communication with or carried by mobile robots, the apparatus 10 may also be embodied by a non-transitory medium, carried by a non-connected transportation device, such as a vehicle, or otherwise be remote from, but in communication with the mobile robots.

As an initial matter, while advertisements are described by way of example to be displayed, other types of messages may also, or alternatively, be displayed, such as emergency information or other types of information that may be useful to pedestrians. When referring to the advertisement type or type of advertisement, this may refer to a specific advertisement or a specific subset of advertisements (e.g., a specific category may be based on the target demographic). The specific subset of advertisements may be determined based on the target demographic, the brand, the subject matter, the amount paid to advertise, and/or the like. Additionally, while the people who are exposed to the mobile message are referred to as pedestrians, they need not be pedestrians. For example, depending on the implementation, those that are exposed to the mobile message may be individuals who are in vehicles or stationary, as opposed to walking.

Referring to Block 300 of FIG. 3, the apparatus 10 includes means, such as the processing circuitry 12, the processor 14, or the like, for accessing a pedestrian location information for the given area. In some embodiments, the pedestrian location information may include or be based on at least one of a historical pedestrian flow, a real-time pedestrian flow, or a digital map of walkways. The pedestrian location information may relate to any portion of the given area. In some instances, the pedestrian location information may be a combination of the historical pedestrian flow, the real-time pedestrian flow, and/or the digital map to create a completely new type of data. For example, certain locations within an area may be ranked (either in absolute or relative terms) based on a combination of at least two of the historical pedestrian flow, the real-time pedestrian flow, and the digital map (e.g., a location may be have 5 star ranking based on the location's position and the amount of historical pedestrian flow). For example, some areas may typically have a high number of pedestrians at a given time and also has large sidewalks that indicate that a high volume is expected. In some embodiments, the pedestrian flow (either real-time or historical) may be derived from public transportation schedules, real-time traffic, POI information, and the like.

In some embodiments, the pedestrian location information may include or be derived at least in part from the historical pedestrian flow. The historical pedestrian flow may be any information relating to the amount and certain characteristics of the pedestrians that are typically at a given location at a given time. Such information may be based on a single occurrence (e.g., one large scale study of a pedestrian area) or multiple occurrences over time (e.g., multiple studies of the demographics at the same location across a length of time). This historical pedestrian flow information may be collected by mobile robots, such as those equipped with an apparatus 10 of an example embodiment, or through other methods of data collection. The amount of historical pedestrian flow information may increase the reliability of the pedestrian location information (e.g., more data points increase the reliability of said data). Using historical pedestrian flow information may also allow a reduction of the processing and/or communication demands place upon a network. For example, using real-time pedestrian flow may strain a network as the amount of devices that upload information may reduce the capacity for other network capabilities to function effectively. Historical pedestrian flow information does not require instantaneous uploading by devices (and/or instantaneous downloading by the apparatus) and may be uploaded and/or downloaded during non-peak times. Additionally, the historical pedestrian flow information may be reused by an apparatus. For example, the apparatus may store the historical pedestrian flow information received, such as in the memory device 16. In such cases, the historical pedestrian flow information stored in the apparatus 10, such as in the memory device 16, may be updated periodically and referenced repeatedly.

Additionally or alternatively, real-time pedestrian flow may be included in the pedestrian location information. The real-time pedestrian flow may be any information relating to the amount and characteristics of the people that are in a given area at or near the current time. In an example embodiment, the real-time pedestrian flow information may be supplied by humans (e.g., an operator could notice high pedestrian traffic at a given area and notify one or more mobile robots), machines (e.g., tracking devices, such as mobile phones, connected to the network), or other mobile robots (e.g., a mobile robot may detect a large volume and determine that additional mobile robots are needed to effectively interact with the crowd). Real-time pedestrian flow may be desirable when there are special events that cause the amount of pedestrians to be drastically different than historical figures. For example, when a city hosts a sporting event, real-time pedestrian flow information may be more accurate in determining the preferable places to advertise if there is not historical information to provide an indication (e.g., some sporting events may happen regularly enough that there is sufficient and predictable historical pedestrian flow). Alternatively, the real-time pedestrian flow information may be used to cross-check the historical pedestrian flow information. For example, the real-time pedestrian flow may be able to account for temporary closed or limited access areas.

In some embodiments, a digital map of walkways may be used alone, or in conjunction, with the pedestrian flow information (real-time and/or historical) to provide pedestrian location information based on the size, location, uniqueness, and other factors of the walkway. For example, the size of the walkways may provide an indication of the amount of people in a given area (e.g., wide squares may attract more people). Additionally, the walkway configuration may give an indication of heavy traffic areas based on the POI data in a given area. For example, there may only be one sidewalk that goes in front of a popular store and therefore the apparatus 10, such as the processing circuitry 12, the processor 14, or the like, may determine that the pedestrian traffic may be higher on the sidewalk. The information relating to the digital walkway may be stored, at least partially, in the apparatus 10, such as in the memory 16, or may be received by the apparatus 10, such as from a map database through the communication interface 20, through the network. As discussed in more detail below, the digital walkway may also be used by the mobile robots to determine the display location and/or the path to get to the display location. In some instances, the digital map of walkways may be stored on the apparatus 10, such as on the memory device 16. In other embodiments, the digital map of walkways may be received by the apparatus 10, such as via the communication interface 20. In some embodiments, the digital map of walkways may be included, either in the apparatus 10 or remotely, in the map database 28 discussed above in reference to FIG. 1.

Referring now to Block 310 of FIG. 3, the apparatus includes means, such as the processing circuitry 12, the processor 14, or the like, for determining a display location containing one or more pedestrians within the given area for the mobile robot to display a mobile message. A mobile message may be any information provided to a pedestrian including, but not limited to, an advertisement. In some embodiments, the mobile message may comprise multiple advertisements. In some embodiments, the determination of the display location may be in response to the provided pedestrian location information and/or based on the position of the mobile robot which will provide the mobile message. In other embodiments, the determination of a display location may also be based on the location of one or more other mobile robots. For example, some mobile robots may already be operating in a popular location and the mobile robot may be deployed to a different location to avoid interfering with the other robot(s). In some embodiments, the apparatus, such as the processing circuitry 12, the processor 14, or the like, may take the pedestrian location information provided for a given area and determine one or more potential display locations to which a mobile message may be displayed. The determination may be based on a desired population density (e.g., semi-crowded sidewalks may allow for better interactions with pedestrians than over crowded sidewalks), the type of advertisement information that may be displayed, the size of the sidewalks, the characteristics of the pedestrians, and/or the like. For example, some mobile robots may have a predetermined type of advertisement, or set of advertisements, which may be used in determining the viable display locations. In some embodiments, the type of advertisement may be determined before the display location is determined. For example, some third parties may buy advertising space on one or more mobile robots for a given amount of time and/or exposure and the display location is determined in part by the type of advertisement. In some embodiments, individual companies may own their own mobile robots that only carry advertisement for their brands. In various embodiments, an apparatus 10, such as the processing circuitry 12, the processor 14, or the like, may be configured to provide one or more display locations to a plurality of mobile robots communicably connected to the apparatus.

In some embodiments, mobile robots may be configured to interact with more people of a certain characteristic (e.g., adults instead of children) and the apparatus 10, such as the processing circuitry 12, the processor 14, or the like, may use the pedestrian location information to determine the locations that would reach the most people (or reach them the most effectively) having that characteristic. For example, there may be a greater density of adults at a bar than at a family restaurant.

In some embodiments, the location of the mobile robot, equipped with or in connection to the apparatus 10 of an example embodiment, may also affect the determined display location. For example, when more than one potential display location is selected based on the pedestrian location information, the location of the mobile robot may affect which display location is chosen for the mobile robot to display a mobile message. In some embodiments, mobile robots, equipped with an apparatus 10 of an example embodiment, may be in communication with one another. For example, an apparatus 10, such as the processing circuitry 12, the processor 14, or the like, may transmit the mobile robot's current or projected position to other apparatuses connected to other mobile robots. In such cases, the location of other mobile robots may determine whether the mobile robot is deployed to a display location. For example, in some cases a display location may be large enough that multiple mobile robots may be deployed without interfering with one another's operation. Alternatively, in some cases, a display location may only allow for a set number of mobile robot (e.g., one) to effectively operate (e.g., there are not enough pedestrians for multiple mobile robots to operate without interfering with one another). In some embodiments, when one or more mobile robots are not needed, or are otherwise not in operation, those mobile robots may have an automated docking system. In some embodiments, the automated docking system may include the mobile robot returning to a designated location, such as a parking garage or warehouse.

Additionally, in some embodiments, the individual mobile robots may have swarm intelligence, where they can communicate with one another to carry out a joint mission or task together working as a team. For example, multiple mobile robots may both operate in a display location providing an advertisement for the same company in complimentary ways (e.g., some mobile robots may be displaying sale items, while the others may be displaying the hours of said sale). In another embodiment, multiple mobile robots may provide the same advertisement at more than one display location (e.g., one robot is in the city square, while another is near another point of interest). In such cases, the mobile robots may work together to determine which display locations will allow the maximum effectiveness of each mobile robot without interfering with one another. For example, there may be more pedestrians in one place, but if the pedestrians have already interacted with a specific advertisement, then the additional viewing may have less of a positive effect on the pedestrians. Alternatively, there may be value to having a single person view the same advertisement multiple times and therefore placing multiple robots displaying the same, or similar, advertisements in close proximity to one another may be effective. In some embodiments, multiple mobile robots are all connected to the same apparatus 10 and the apparatus 10, such as the processing circuitry 12, the processor 14, or the like, provides instructions that may facilitate swarm intelligence cooperation between the connected mobile robots.

In some embodiments, the location that the advertisement is being displayed may factor into the advertisement's effectiveness. For example, for brick and mortar stores and restaurants, the effectiveness of the advertisement may be tied to the proximity of the advertisement to the establishment (e.g., pedestrians may make the split second decision to eat at a restaurant in close proximity). Additionally, as discussed in more detail below in reference to optional Block 320, it may be advantageous to advertise certain types of goods or services in certain areas and/or at certain times. For example, a high-end, professional clothing store may have more effective advertisements in an area where a large amount of the pedestrians wear high-end, professional clothes, such as the banking district, than in other areas where fewer people wear high-end, professional clothing. In some embodiments, the mobile robots may be configured to determine and measure foot traffic in a retail location or business by monitoring pedestrians after seeing certain advertisements.

Referring now to optional Block 320 of FIG. 3, the apparatus 10 includes means, such as the processing circuitry 12, the processor 14, or the like, for determining the advertisement information to be provided based on at least one characteristic of the one or more pedestrians in the display location. In some embodiments, the at least one characteristic of the one or more pedestrians in the display location used to determine the advertisement information to be provided may include at least one of gender, age, height, or weight. The apparatus 10, such as the processing circuitry 12, the processor 14, or the like, may be configured either dynamically, such as by a pedestrian, or statically, such as being pre-programmed, to focus on one or more specific characteristics from the pedestrian location information. For example, the apparatus 10, such as the processing circuitry 12, the processor 14, or the like, may be configured to use the gender breakdown of the display location and provide different advertisements based on the gender breakdown. In such a case, the apparatus 10, such as the processing circuitry 12, the processor 14, or the like, may be in communication with the map database 28 to indicate the desired gender breakdown. In a case that the gender breakdown is not provided, or is not available to the apparatus, the apparatus 10, such as the processing circuitry 12, the processor 14, or the like, may have a preset advertisement to provide to a display location. For example, the apparatus 10, such as the processing circuitry 12, the processor 14, or the like, may display one of the advertisements that would typically target a specific gender or may display a different advertisement. In some embodiments, a mobile robot may be designed to display different advertisements based on the age demographics of the display location. For example, the mobile message may be an advertisement for an alcoholic drink or nightclub when there are few pedestrians present under the legal drinking age, while it may display soft drinks when there are a sufficient number of pedestrians present under the legal drinking age.

As discussed in more detail below, in some embodiments, the apparatus 10 may have means, such as the processing circuitry 12, the processor 14, or the like, for performing facial and/or gesture recognition on pedestrians. In such a case, the apparatus 10, such as the processing circuitry 12, the processor 14, or the like, may use this information to determine characteristics of some or all of the pedestrians in the display location. For example, the apparatus 10, such as the processing circuitry 12, the processor 14, or the like, may be configured to infer the gender of one or more pedestrians based on the facial and/or gesture recognition. In some embodiments, the apparatus 10, such as the processing circuitry 12, the processor 14, or the like, may also choose an advertisement to display based on the recognition (e.g., the characteristics or body language of the pedestrians may affect the selection of advertisement). In some embodiments, the mobile robot may target a specific characteristic of the pedestrian in determining which pedestrians to approach.

In some embodiments, the determination of the type of advertisement to be displayed may be made independent of the display location. For example, the determination of the type of advertisement may be decided before the display location is determined (e.g., a brand contracts to have their advertisement on a specific robot regardless of location) or with no regard to the display location (e.g., the type of advertisement displayed may be time based). In other embodiments, the determination of the type of advertisement may be determined based at least in part on the display location. For example, there may be a tiered system that allows those advertising to select the amount of pedestrians or target demographics they want their advertisement to reach (e.g., reaching more people in populated areas may cost more for the companies advertising). In such an example, advertisements may have a designation to only be played in areas having a certain density of pedestrians. For example, some advertisements may be tailored to a certain size and type of crowd. Additionally, there may be similar designations for the demographic characteristics discussed above (e.g., a company may only care about their advertisement being seen by 18-24 year olds).

Referring now to Block 330 of FIG. 3, the apparatus 10 includes means, such as the processing circuitry 12, the processor 14, or the like, for providing advertisement information to be included in the mobile message to be transmitted by the mobile robot to at least one of the one or more pedestrians in the display location. In some embodiments, one advertisement may make up the entire mobile message. In other embodiments, the advertisement information may make up part, but not all of the mobile message. The mobile message may include one or more advertisements in addition to other types of messages (e.g., entertainment videos) and may be delivered in any advertisement format. As discussed above, the advertisement information may be any information that allows the apparatus 10, such as the processing circuitry 12, the processor 14, or the like, to provide a certain advertisement as a part of the mobile message. In other words, the advertisement information provides an indication on the advertisement to be played by the apparatus 10. In some embodiments, the indication may be the actual advertisement to be shown as a part of the mobile message. For example, the advertisement information may be the advertisement that should be used in the mobile message. Alternatively, the indication may instruct the apparatus 10, such as the processing circuitry 12, the processor 14, or the like, to display a certain advertisement, but not actually contain the advertisement. For example, the advertisement information provided may indicate that a toy advertisement may be appropriate, such that the apparatus 10, such as the processing circuitry 12, the processor 14, or the like, may then choose from one or more toy advertisements through the network or stored in the apparatus. In some embodiments, the mobile robot may have more than one advertisement stored and the advertisement information instructs the apparatus 10, such as the processing circuitry 12, the processor 14, or the like, on which of the stored advertisements to provide to pedestrians.

Additionally, the advertisement to be provided may undergo a transformation by the apparatus 10, such as the processing circuitry 12, the processor 14, or the like, before being provided to pedestrians. In some embodiments, the advertisement may not be able to be provided appropriately when received by the apparatus 10. For example, an advertisement may be sent to a plurality of mobile robots and each mobile robot may have different capabilities (e.g., screen resolution and size). In such a case, the apparatus 10 may be equipped to optimize, such as by the processor 14, the advertisement for the given mobile robot and the given mobile message to permit proper display, such as by tailoring the message to the screen resolution and/or size of the mobile robot.

As discussed above, in some embodiments, the advertisement information provided may be based on the determined display location. In some embodiments, the advertisement makes up the entire mobile message (e.g., the mobile robot may have a screen that shows an advertisement). Alternatively, the advertisement may be presented with other advertisements and/or with additional non-advertisement information, such as entertainment content to attract attention. For example, the mobile message may include a video clip with one or more advertisements alongside the clip. Additionally, there may be different sized advertisements based on the cost and function of the advertisement (e.g., interactive advertisements may be more expensive).

In some embodiments, the advertisement may be visual and/or audible. For example, the advertisement may be a picture (e.g., a picture advertising a certain amount off during a sale). In some embodiments, the advertisement may be a video. In other embodiments, the advertisement may be a combination of still pictures and videos. Additionally, sound may accompany any visual advertisement information. Alternatively, the advertisement may be only audible.

In some embodiments, the advertisement information may be configured to allow pedestrians passing by to interact with the advertisement. In an example embodiment, pedestrians may be able to select, such as on a user interface 22, between multiple advertisements or select an advertisement based on their interest (e.g., a pedestrian may be interested in finding a restaurant nearby). In some embodiments, the pedestrians may be able to input information relating to the effectiveness of the advertisement (e.g., a rating of 1 to 5 stars). Additionally, the pedestrians may be able to interact with the mobile message to receive additional information and/or rewards. For example, a pedestrian may be able to input personal information, such as their name, phone number, email address, or the like, and in return get a discount from a specific advertiser. In such a case, the discount may be conveyed to the pedestrians visually (e.g., displaying a promo code), audibly (e.g., a promo code is conveyed to the pedestrian through a speaker), physically (e.g., the mobile robot is equipped with a coupon dispenser), or virtually (e.g., sent in the form of a text or email based on the input from the pedestrian). In some embodiments, the input from the pedestrian may then be stored and/or transmitted to a network, where the input may be used to create a database of information and/or added to existing databases, such as a brand's email database. The information may also be stored in a way that allows the pedestrian to quickly enter their information on that or another mobile robot during subsequent interaction (e.g., the next time a pedestrian interacts with a mobile robot connected to the network, the pedestrian may only be required to enter their phone number for the apparatus 10 to recognize the pedestrian's information).

In some embodiments, the apparatus 10 also includes means, such as the processing circuitry 12, the processor 14, or the like, for selecting at least one of the one or more pedestrians in the display location to display the mobile message based on at least one characteristic of the one or more pedestrians in the display location. In some embodiments, the number of pedestrians interacted with by a mobile robot depends on the type of advertisement, the display location, and/or the capabilities of the mobile robot. For example, some types of advertisements are more effective when delivered to an individual, or small group of individuals, such as the interactive advertisements discussed above, while some, such as a video or picture, may be conveyed to multiple pedestrians simultaneously without substantially reducing the effectiveness of the advertisement. In some embodiments, the display location may also dictate the number of pedestrians with which the mobile robots interact. In such a case, the amount of pedestrians and their amount of time spent in the display location will affect the amount of pedestrians that can be effectively reached. For example, in high density areas of the city, there may be a large amount of pedestrians that pass quickly and therefore the advertisement may be configured to be conveyed as quickly as possible to as many pedestrians as possible. Alternatively, in less dense areas, pedestrians may be able to stop and interact for longer with the mobile robots allowing the advertisement information to be more substantive, but the overall amount of pedestrians with which the mobile robot interacts may be less. Additionally, some advertisements are tailored to reach many people quickly. In some embodiments, the mobile robot may only be equipped to reach a certain amount of pedestrians in a set amount of time. For example, some mobile robots may have larger screens than other mobile robots, while some mobile robots may not be able to move through crowds as quickly, thereby reducing the number of pedestrians with which the mobile robots can interact in a set period of time.

In some embodiments, the apparatus 10 also includes means, such as the processing circuitry 12, the processor 14, or the like, for selecting at least one of the one or more pedestrians to display the mobile message based on at least one of facial recognition or gesture recognition. In other embodiments, the apparatus 10, such as the processing circuitry 12, the processor 14, or the like, may include, or be in communication with sensors that allow for facial, gesture, and/or sound recognition to be used to determine interested pedestrians. For example, the apparatus 10, such as the processing circuitry 12, the processor 14, or the like, may be able to determine whether a pedestrian may be receptive to the advertisement information based on the facial expression (e.g., a pedestrian that is interested may be smiling, while an uninterested pedestrian may be frowning), gestures (e.g., an uninterested pedestrian may be looking the other direction or make a gesture towards the mobile robot), or sound (e.g., an uninterested pedestrian may say “No, thanks”). Facial recognition may also be configured to recognize people based on previous interactions between that person and a mobile robot. For example, a pedestrian may consent to being automatically recognized by a connected mobile robot during a previous interaction. In some embodiments, the apparatus 10, such as the processing circuitry 12, the processor 14, or the like, may be configured to have a “do not disturb” function in regards to one or more pedestrians when one of the above recognized responses or actions indicates that a pedestrian is uninterested. In such a case, the apparatus 10, such as the processing circuitry 12, the processor 14, or the like, may then target a pedestrian that is determined to be “interested” instead of targeting the uninterested pedestrians. In some embodiments, the apparatus 10, such as the processing circuitry 12, the processor 14, or the like, may be able to determine information about the pedestrians using the facial, gesture, and/or sound recognition. For example, the apparatus 10, such as the processing circuitry 12, the processor 14, or the like, may be able to recognize a certain type of jewelry on a given pedestrian. The apparatus 10, such as the processor 14, may use this information to determine either the type of advertisement information to display or which pedestrians to which to display certain advertisement information (e.g., a mobile robot may target a pedestrian with expensive ear rings and display an advertisement for other types of jewelry). In various embodiments, the facial, gesture, and/or sound recognition may be allowed by one or more sensors in communication with the apparatus and, more particularly, the processor. For example, a sensor (e.g., a camera) may provide data relating to one or more pedestrian's facial expression for analysis by the processor in order to direct subsequent action. In some embodiments, a machine learning technique, such as deep machine learning system based on artificial neural network architecture, may be employed in conjunction with one or more visual sensors for the facial and/or gesture recognition discussed above.

Referring now to optional Block 340 of FIG. 3, the apparatus 10 includes means, such as the processing circuitry 12, the processor 14, or the like, for causing the transmission of the mobile message to at least one of the one or more pedestrians in the display location. In some embodiments, the mobile message provided by the mobile robot includes at least one of a visual or an audible signal. For example, the mobile robots may be equipped with a visual display and/or a speaker to provide the mobile message. In an example embodiment, the at least one of the one or more pedestrians in the display location may interact with the mobile message. In some embodiments, the interaction of a pedestrian results in a change in the advertisements. For example, the pedestrians may not be interested in a specific advertisement and be able to change to another advertisement. Alternatively, the pedestrian may be able to decide between multiple advertisements to view. For example, a pedestrian may indicate that they would like a restaurant recommendation.

In such cases, an example embodiment of the apparatus 10 also includes means, such as the processing circuitry 12, the processor 14, or the like, for altering the mobile message based on the interaction by the at least one of the one or more pedestrians in the display location. As stated above, the alteration may include changing the advertisement. In some embodiments, the advertisement size may be altered (e.g., a pedestrian may be able to click on an advertisement and enlarge said advertisement). In such a case where pedestrians can interact with the mobile message, the apparatus 10 also includes means, such as the processing circuitry 12, the processor 14, or the like, for collecting data based on the interactions with the at least one of the one or more pedestrians. The data may then be used subsequently by the apparatus 10. The data collected by the apparatus 10 may include pedestrian recognition (e.g., how many pedestrians actually engage with the mobile robot), pedestrian reaction to an advertisement (e.g., a positive or negative reaction to viewing a mobile message), and the movement of pedestrians after viewing a mobile message (e.g., for an advertisement of a nearby store, the mobile robot may track which pedestrians go towards or into the nearby store).

In some embodiments, the apparatus 10 includes means, such as the processing circuitry 12, the processor 14, or the like, for interacting with one or more additional robots, equipped with example embodiments of the apparatus 10, to provide one or more mobile messages to more than one display location. For example, there may be multiple areas that have busy pedestrian traffic during lunch and therefore multiple mobile robots may be able to operate effectively without fear of interference. In such an example, the mobile robots may have varying amounts of functionality including the method of delivering mobile messages (e.g., some mobile robots may have large screens, while others have little screens or none at all), the mobility of the mobile robot (e.g., some mobile robots may not be able to travel as far or as quickly as others), and the size of the mobile robots (e.g., some mobile robots may be larger than others). In some embodiments, one mobile robot may be designated the master robot of a group of one or more mobile robots in a given area. In such an example, the master robot may be able to use extra sensors and/or hardware to relay messages to the group of one or more robots nearby, such as through proximity based protocols such as NFC or Bluetooth communications. Additionally, in some embodiments, the master mobile robot of a group may plan and direct the other mobile robots in the group. In an example embodiment, the apparatus 10 includes means, such as the processing circuitry 12, the processor 14, or the like, for using the functionality of the mobile robot that the apparatus is controlling, as well as other mobile robots connected to the network in order to direct the behavior of the mobile robots. In other words, the apparatus 10, such as the processing circuitry 12, the processor 14, or the like, instructs at least one mobile robot where and how to operate at a given time.

In an example embodiment, the apparatus 10 includes means, such as the processing circuitry 12, the processor 14, or the like, for tracking the amount of pedestrians in the display location. In some embodiments, the apparatus 10, such as the processing circuitry 12, the processor 14, or the like, may actively track the amount of pedestrians in the display area (e.g., the apparatus 10 may be equipped with a tracking device). Alternatively, the apparatus 10, such as the processing circuitry 12, the processor 14, or the like, may collect information from which the amount of pedestrians on the road can be derived. For example, the total amount of pedestrians in an area may be derivable based on the number of pedestrians the mobile robot is able to interact with during a given time (e.g., the number of pedestrians that the mobile robot interacts with may be dependent upon the total amount of people). In some embodiments, the apparatus 10, such as the processing circuitry 12, the processor 14, or the like, may track the amount of pedestrians which give a certain reaction, e.g., a verbal or non-verbal reaction, to the mobile robot (e.g., the amount of positive responses may be tracked by the mobile robot).

Additionally, the apparatus 10, such as the processing circuitry 12, the processor 14, or the like, of an example embodiment may track the engagement rate of pedestrians in a display location. In some embodiments, the engagement rate may be determined in different ways, including the number of people that interact with an advertisement (for interactive advertisements), the body language of pedestrians when interacting with the mobile robot, and/or the amount of time spent by pedestrians who observe the advertisement. For example, an apparatus 10, such as the processing circuitry 12, the processor 14, or the like, may track the percentage of people that stop, or slow down, to look at an advertisement and, either additionally or alternatively, the amount of time that those pedestrians stay within view of the advertisement. Some locations may have higher amounts of pedestrians engage (e.g., in a business area, the people may be less likely to interact with a mobile robot than in an entertainment area). Some locations may have less pedestrians initially engage, but the ones that do stop stay engaged longer. The engagement statistics may be stored and/or transmitted to the network to be used during subsequent use of the apparatus 10 or similar apparatus including for the determination of potential display locations. In such cases, the engagement rates may affect subsequent determinations of a display location by an apparatus 10. In some embodiments, the engagement rate may be used by mobile robot providers and advertisers alike in determining which areas of a city would be best to deploy mobile robots and which types of advertisements work best at those locations.

Referring now to FIG. 4, an example configuration of the network that one or more mobile robots, equipped, or in communication, with an apparatus 10, such as through the communication interface 20 or the like, may be connected is provided. As shown, multiple mobile robots may all be connected to the same network 400. In some embodiments, the mobile robots may communicate with one another through the network 400. In other embodiments, the mobile robots may communicate with one another independent of the network 400, such as using NFC or Bluetooth technologies. In some embodiments, the mobile robots may operate independent of the network shown in FIG. 4. For example, the mobile robots may be connected to one another using NFC or Bluetooth technologies. In some embodiments, the apparatus 10 may be remote from the mobile robot and connected through the network. For example, the apparatus 10 may be stored in the intelligence location server 420.

Referring now to provider block 410 of FIG. 4, the potential third party providers of information may be provided. These providers may provide varying amounts of information relating to advertisements. In an example embodiment, the providers may include an Advertising Technology (AdTech) provider 410A, a multimedia provider 410B, and/or an applications provider 410C. In an example embodiment, a multimedia provider may provide different advertisement formats. In some embodiments, an application provider may provide different functionality and features for an advertisement (e.g., allowing some advertisements to be interactive). In some embodiments, AdTech may be any technology that allows for the buying and selling of advertisements, and specifically targeting specific audiences and individuals. For example, AdTech may include databases of digital identities called demand-side platforms, and data management platforms, or the advertising networks and exchanges that publishers use to sell their digital advertisement space. In some embodiments, AdTech may have gathered data from example embodiments of the apparatus 10 and/or other sources to create the targeted advertisements. In an example embodiment, AdTech providers may supply one or more advertisements tagged with one or more certain demographic characteristic of pedestrians the advertisement should target. In such a case, the apparatus 10, such as the processing circuitry 12, the processor 14, or the like, may determine which advertisement to display based on the audience information and the target information for a specific advertisement. For example, an advertisement for toys may target pedestrians who are a certain age (e.g., pedestrians age 30-40 may be the most likely to have children interested in a given toy) and the apparatus 10, such as the processing circuitry 12, the processor 14, or the like, may determine to cause the advertisement to be displayed in areas where there are a certain amount of pedestrians in that age range. In some embodiments, the AdTech may be provided by companies that are buying advertising space on a mobile robot. Alternatively, there may be a third party company that provides AdTech in relation to an advertisement provided from elsewhere (e.g., first, second, or third party advertisements). In some embodiments, the location intelligence server 420 may either additionally or alternatively be equipped with AdTech. As shown in FIG. 4, the AdTech provider 410A may be connected to the Location Intelligence 420 and/or the Network 400. In some embodiments, there may be similar information or functionality provided by a first party. In some embodiments, there may be other providers used in conjunction with, or in addition to, the providers discussed above (e.g., a provider may provide news and/or social media data).

In some embodiments, the third party providers may provide information to various servers, such as the location intelligence server 420, through the network 400. In some embodiments, the information from the third party providers may be directly supplied to the apparatus 10. Alternatively, the information may undergo a transformation before being provided to the apparatus 10. The information from the third party providers may include an advertisement, a target audience, a target timeframe of running the advertisement, the medium of the advertisement, and/or the like. For example, a third party may provide an advertisement that was previously made with instructions for the mobile robot to target a specific age group during a certain time of day, week, or year (e.g., the third party may want to target young professionals after work hours). In some embodiments, the apparatus 10, such as the processing circuitry 12, the processor 14, or the like, may also return information to the third party providers. For example, the apparatus 10, such as the processing circuitry 12, the processor 14, or the like, may return information relating to engagement rates of pedestrians and how well the actual demographics of the location matched the predicted demographics for said location.

In some embodiments, a location intelligence server 420 may be provided either as a part of the apparatus 10 or in communication with the apparatus 10, such as through the communication interface 20 or the like. For example, the location intelligence server 420 may be configured to provide information to the apparatus 10. Additionally or alternatively, the location intelligence server may be a part of the apparatus 10 of an example embodiment. In some embodiments, the location intelligence server 420 may provide localization information relating to one or more mobile robots and/or pedestrians to assist in the determination of an advertisement to display. In some embodiments, the location intelligence server 420 may provide instructions to the mobile robots to follow relating to the display location and type of advertisements. In some embodiments, the location intelligence server 420 may receive information from the third party providers 410. In such cases, the location intelligence server may use this information to create pedestrian location information for the apparatus 10 of an example embodiment to use in determining a display location. Additionally or alternatively, the location intelligence server 420 may be configured to choose a type of advertisement to be displayed by one or more robots based on information received from the third party providers and/or the mobile robots 200.

FIG. 3 illustrate a flowchart of an apparatus, method and computer program product according to example embodiments of the invention. It will be understood that each block of the flowchart, and combinations of blocks in the flowchart, may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 16 of an apparatus 10 employing an embodiment of the present invention and executed by a processing circuitry 12 of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, some of which have been described above. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for mobile advertising within a given area, the method comprising:
accessing pedestrian location information for the given area,
wherein the pedestrian location information is based on at least one of a historical pedestrian flow, a real-time pedestrian flow, or a digital map of walkways;
in response to the provided pedestrian location information and based on a position of a mobile robot, determining a display location containing one or more pedestrians within the given area for the mobile robot to display a mobile message; and
based on the display location determined, providing advertisement information to be included in the mobile message to be provided by the mobile robot to at least one of the one or more pedestrians in the display location.

2. The method according to claim 1, wherein the determination of a display location is also based on the location of one or more other mobile robots.

3. The method according to claim 1 further comprising altering the mobile message based on an interaction by at least one of the one or more pedestrians in the display location.

4. The method according to claim 1 further comprising collecting data based on one or more interactions with at least one of the one or more pedestrians.

5. The method according to claim 1 further comprising determining the advertisement information to be provided based on at least one characteristic of the one or more pedestrians in the display location, wherein the at least one characteristic of the one or more pedestrians in the display location used to determine the advertisement information to be provided includes at least one of gender, age, height, or weight.

6. The method according to claim 1 further comprising selecting the at least one of the one or more pedestrians in the display location to display the mobile message based on at least one characteristic of the one or more pedestrians in the display location.

7. The method according to claim 1 further comprising selecting the at least one of the one or more pedestrians to display the mobile message based on at least one of facial recognition or gesture recognition.

8. The method according to claim 1 further comprising interacting with one or more additional robots to provide one or more mobile messages to more than one display location.

9. The method according to claim 1 further comprising causing the transmission of the mobile message to at least one of the one or more pedestrians in the display location.

10. An apparatus for determining a location of a mobile advertisement robot, the apparatus comprising at least one processor and at least one non-transitory memory including computer program code instructions, the computer program code instructions configured to, when executed, cause the apparatus to:
access pedestrian location information for the given area,
wherein the pedestrian location information is based on at least one of a historical pedestrian flow, a real-time pedestrian flow, or a digital map of walkways;
in response to the provided pedestrian location information and based on a position of a mobile robot, determine a display location containing one or more pedestrians within the given area for the mobile robot to display a mobile message; and
based on the display location determined, provide advertisement information to be included in the mobile message to be provided by the mobile robot to at least one of the one or more pedestrians in the display location.

11. The apparatus according to claim 10, wherein the determination of a display location is also based on the location of one or more other mobile robots.

12. The apparatus according to claim 10, wherein the computer program code instructions are further configured to, when executed, cause the apparatus to alter the mobile message based on one or more interactions by at least one of the one or more pedestrians in the display location.

13. The apparatus according to claim 10, wherein the computer program code instructions are further configured to, when executed, cause the apparatus to collect data based on one or more interactions with at least one of the one or more pedestrians.

14. The apparatus according to claim 10, wherein the computer program code instructions are further configured to, when executed, cause the apparatus to determine the advertisement information to be provided based on at least one characteristic of the one or more pedestrians in the display location, wherein the at least one characteristic of the one or more pedestrians in the display location used to determine the advertisement information to be provided includes at least one of gender, age, height, or weight.

15. The apparatus according to claim 10, wherein the computer program code instructions are further configured to, when executed, cause the apparatus to select the at least one of the one or more pedestrians in the display location to display the mobile message based on at least one characteristic of the one or more pedestrians in the display location.

16. The apparatus according to claim 10, wherein the computer program code instructions are further configured to, when executed, cause the apparatus to select the at least one of the one or more pedestrians to display the mobile message based on at least one of facial recognition or gesture recognition.

17. The apparatus according to claim 10, wherein the computer program code instructions are further configured to, when executed, cause the apparatus to cause the transmission of the mobile message to at least one of the one or more pedestrians in the display location.

18. A computer program product comprising at least one non-transitory computer-readable storage medium having computer-executable program code portions stored therein, the computer-executable program code portions comprising program code instructions configured to:
access pedestrian location information for the given area,
wherein the pedestrian location information is based on at least one of a historical pedestrian flow, a real-time pedestrian flow, or a digital map of walkways;
in response to the provided pedestrian location information and based on a position of a mobile robot, determine a display location containing one or more pedestrians within the given area for the mobile robot to display a mobile message; and
based on the display location determined, provide advertisement information to be included in the mobile message to be provided by the mobile robot to at least one of the one or more pedestrians in the display location.

19. The computer program product according to claim 18, wherein the determination of a display location is also based on the location of one or more other mobile robots.

20. The computer program product according to claim 18, wherein the program code instructions are further configured to alter the mobile message based on one or more interactions by at least one of the one or more pedestrians in the display location.

21. The computer program product according to claim 18, wherein the program code instructions are further configured to determine the advertisement information to be provided based on at least one characteristic of the one or more pedestrians in the display location, wherein the at least one characteristic of the one or more pedestrians in the display location used to determine the advertisement information to be provided includes at least one of gender, age, height, or weight.

22. The computer program product according to claim 18, wherein the program code instructions are further configured to select the at least one of the one or more pedestrians in the display location to display the mobile message based on at least one characteristic of the one or more pedestrians in the display location.

23. The computer program product according to claim 18, wherein the program code instructions are further configured to cause the transmission of the mobile message to at least one of the one or more pedestrians in the display location.
